(19) United States
(12) Patent Application Publication
(10) Pub. No.: US 2024/0121724 A1
(43) Pub. Date: Apr. 11, 2024

(54) METHOD AND APPARATUS FOR MID PACKET WAKE UP PROTECTION AFTER OBSS PD SPATIAL REUSE

(71) Applicant: Samsung Electronics Co., Ltd., Suwon-si (KR)

(72) Inventors: Abhishek Sehgal, Frisco, TX (US); Vishnu Vardhan Ratnam, Plano, TX (US); Hao Chen, Allen, TX (US); Boon Loong Ng, Plano, TX (US)

(21) Appl. No.: 18/479,727

(22) Filed: Oct. 2, 2023

Related U.S. Application Data
(60) Provisional application No. 63/413,881, filed on Oct. 6, 2022.

(51) Int. Cl. H04W 52/24; H04W 74/08

(52) U.S. Cl. CPC H04W 52/243; H04W 74/0808

(57) ABSTRACT

Methods and apparatuses for prioritization handling for mid packet wake up protection after OBSS PD spatial reuse are disclosed. A method for wireless communication performed by a communication device comprises transmitting and receiving traffic for an application in an overlapping basic service set preamble detection (OBSS-PD) operation; and reducing a transmission power of the communication device, to reduce adding interference to an inter-basic service set (inter-BSS) physical layer protocol data unit (PPDU) that the communication device is transmitting over, based on energy detection (ED) and in accordance with a channel access procedure or a transmission power reduction procedure.

### CROSS-REFERENCE TO RELATED APPLICATION AND CLAIM OF PRIORITY

This application claims priority under 35 U.S.C. § 119(e) to U.S. Provisional Patent Application No. 63/413,881 filed on Oct. 6, 2022, which is hereby incorporated by reference in its entirety.

### TECHNICAL FIELD

This disclosure relates generally to transmission efficiency in wireless communications systems. Embodiments of this disclosure relate to methods and apparatuses for mid packet wake up protection after overlapping basic service set preamble detection (OBSS PD) spatial reuse.

### BACKGROUND

Wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

With the standardization process of the next generation IEEE 802.11 wireless local area network (WLAN), i.e., IEEE 802.11ax amendment entering the final stage, the IEEE 802.11ax amendment is drawing attention of the information technology (IT) industry. It newly introduces features for improving peak throughput and efficiency in an environment crowded by many 802.11 devices. Example environments include airports, stadiums, and so on. WI-FI alliance (WFA) has already launched the WI-FI 6 certification program for guaranteeing interoperability between certified products implementing IEEE 802.11ax amendment. In the market, device manufacturers are already starting to release WI-FI 6 certified smart mobile devices.

### SUMMARY

Embodiments of the present disclosure provide methods and apparatuses for mid packet wake up protection after OBSS PD spatial reuse.

In one embodiment, a communication device is provided, comprising: a transceiver configured to transmit and receive traffic for an application in an OBSS-PD operation. The communication device further comprises a processor operably coupled to the transceiver, the processor configured to: reduce a transmission power of the communication device, to reduce adding interference to an inter-basic service set (inter-BSS) physical layer protocol data unit (PPDU) that the communication device is transmitting over, based on energy detection (ED) and in accordance with a channel access procedure or a transmission power reduction procedure.

In another embodiment, an AP device is provided, comprising: a processor configured to generate traffic for an application in an OBSS-PD operation. The AP device further comprises a transceiver operably coupled to the processor, the transceiver configured to: transmit the traffic for the application in the OBSS-PD operation; and receive an inter-BSS PPDU from a communication device, the inter-BSS PPDU having a reduced transmission power to reduce interference to the inter-BSS PPDU that the communication device is transmitting over, based on ED and in accordance with a channel access procedure or a transmission power reduction procedure.

In yet another embodiment, a method for wireless communication performed by a communication device comprises: transmitting and receiving traffic for an application in an OBSS-PD operation; and reducing a transmission power of the communication device, to reduce adding interference to an inter-BSS PPDU that the communication device is transmitting over, based on ED and in accordance with a channel access procedure or a transmission power reduction procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example STA according to embodiments of the present disclosure;

FIG. 3 illustrates an example adjustment for TX_PWR in relation to OBSS_PD level according to embodiments of the present disclosure;

FIG. 4 illustrates an example topology involving two overlapping BSSs according to embodiments of the present disclosure;

FIG. 5 illustrates an example packet transmission diagram involving multiple STAs in overlapping BSSs according to embodiments of the present disclosure;

FIG. 6 illustrates an example channel access procedure involving reducing the energy detection (ED) threshold until the energy in the channel falls below the preamble detection threshold according to embodiments of the present disclosure;

FIG. 7 illustrates an example involving delaying carrier sensing for a duration of time according to embodiments of the present disclosure;

FIG. 8 illustrates an example involving reducing transmit power if energy sensed on the channel is less than the OBSS PD threshold according to embodiments of the present disclosure;

FIG. 9 illustrates an example involving duration alignment between the OBSS PD transmission and the overlapping inter-BSS physical layer protocol data unit (PPDU) according to embodiments of the present disclosure; and

FIG. 10 illustrates an example of a method for wireless communication performed by a communication device according to embodiments of the present disclosure.

### DETAILED DESCRIPTION

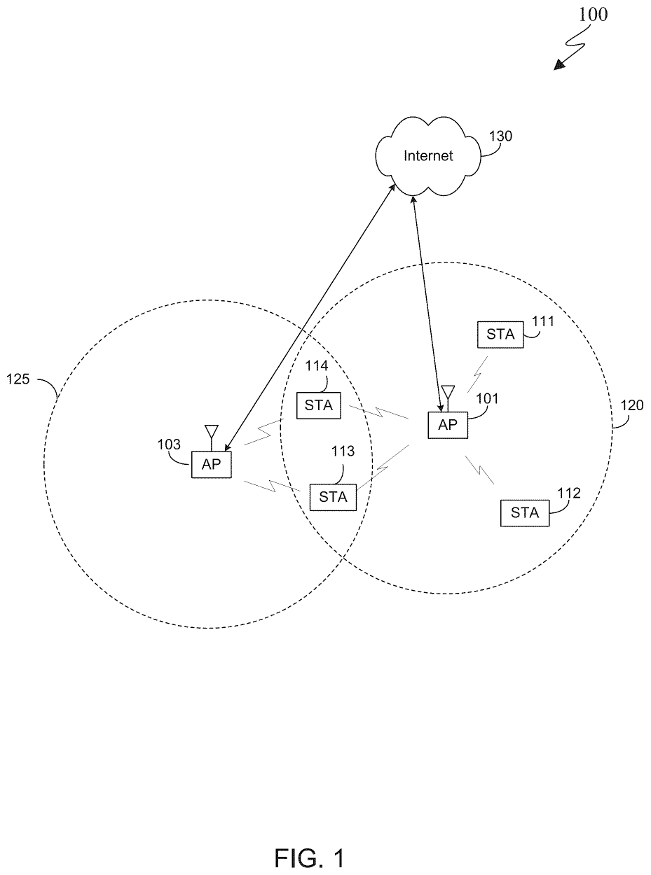

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE 802.11-2020, “Wireless LAN Medium Access Control (MAC) and Physical Layer (PHY) Specifications”; [2] IEEE P802.11ax/D8.0, “Wireless LAN Medium Access Control (MAC) and Physical Layer (PHY) Specifications”; [3] IEEE P802.11be/D2.0, “Wireless LAN Medium Access Control (MAC) and Physical Layer (PHY) Specification”.

Embodiments of the present disclosure provide mechanisms for mid packet wake up protection after OB SS PD spatial reuse.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating mid packet wake up protection after OBSS PD spatial reuse. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

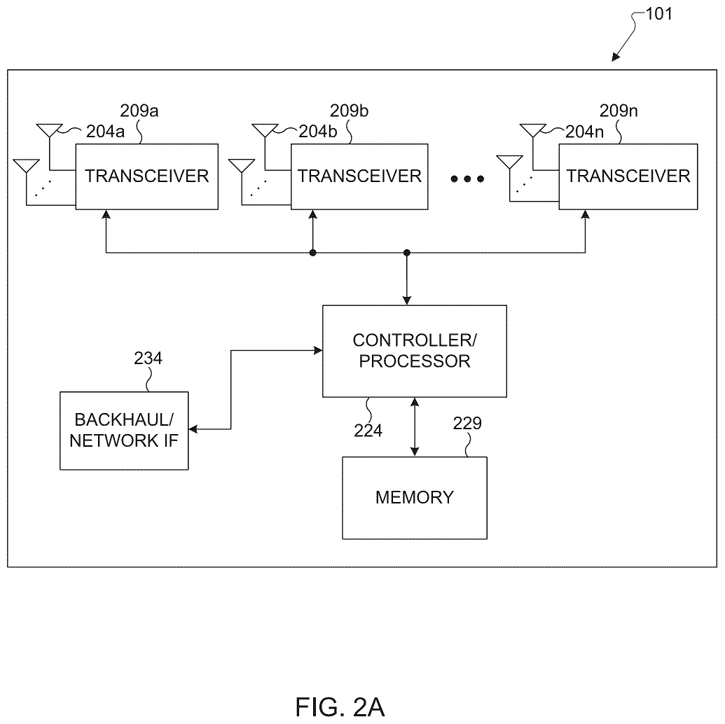

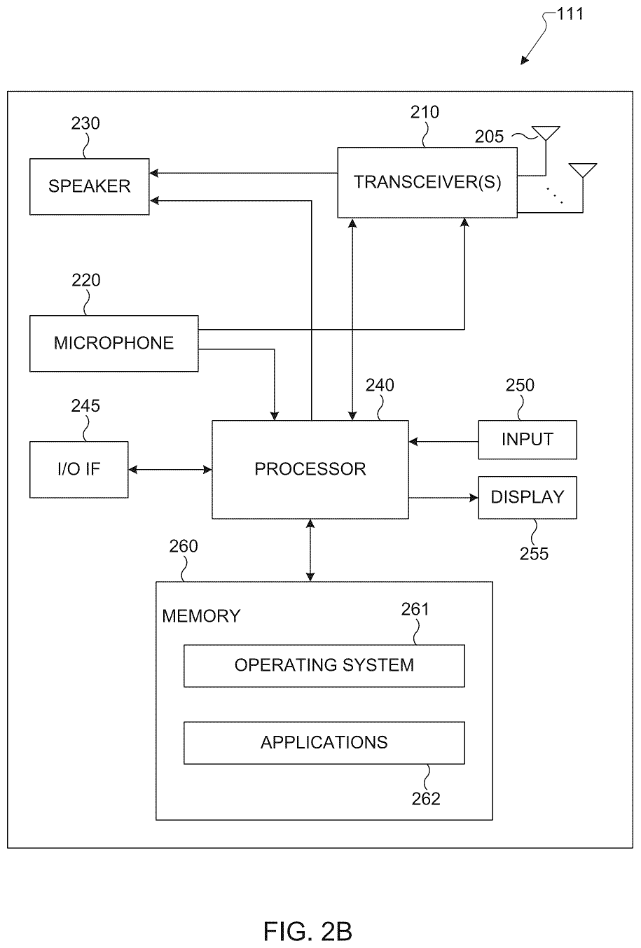

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating mid packet wake up protection after OBSS PD spatial reuse. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating mid packet wake up protection after OBSS PD spatial reuse. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna (or antennas) 205, a radio frequency (RF) transceiver (or transceivers) 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate mid packet wake up protection after OBSS PD spatial reuse. In some embodiments, the controller/processor 240 includes at least one microprocessor or microcontroller.

The controller/processor 240 is also capable of executing other processes and programs resident in the memory 260, such as operations for facilitating mid packet wake up protection after OB SS PD spatial reuse. The controller/processor 240 can move data into or out of the memory 260 as required by an executing process. In some embodiments, the controller/processor 240 is configured to execute a plurality of applications 262, such as applications for facilitating mid packet wake up protection after OBSS PD spatial reuse. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

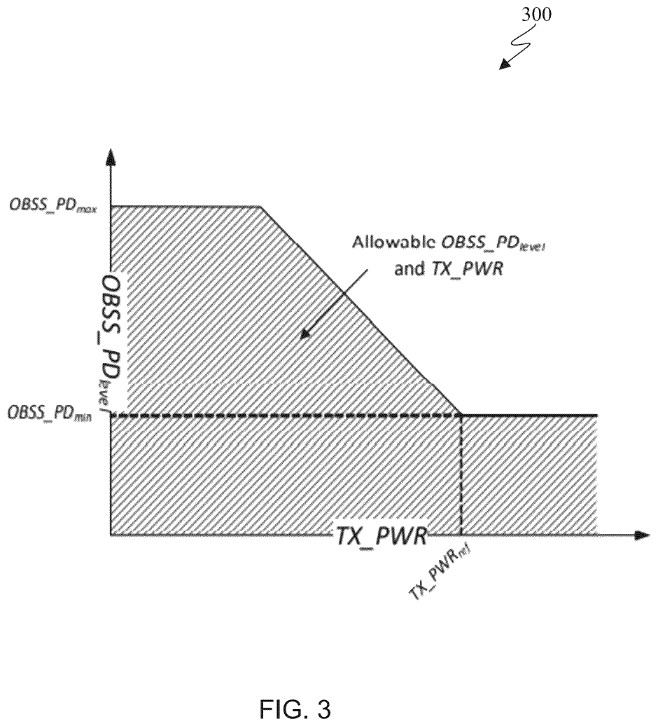

FIG. 3 illustrates an example adjustment for TX_PWR in relation to OBSS_PD level 300 according to embodiments of the present disclosure. The embodiment of the example adjustment for TX_PWR in relation to OBSS_PD level 300 shown in FIG. 3 is for illustration only. Other embodiments of the example adjustment for TX_PWR in relation to OBSS_PD level 300 could be used without departing from the scope of this disclosure.

The IEEE 802.11ax amendment introduces basic service set (BSS) coloring as a scheme to allow early detection of overlapping BSS (OBSS) transmission and spatial reuse (SR) through an adaptive clear channel assessment (CCA) threshold with transmission power control (TPC) to increase spectral efficiency in dense Wi-Fi deployments. Earlier amendments have relied on fixed CCA thresholds based on whether an 802.11 preamble has been detected or not to determine if the medium is IDLE or not. If an 802.11 preamble is detected, then the node uses a preamble detection (PD) threshold to declare the medium as IDLE. In the absence of an 802.11 preamble, the node resorts to an energy detection (ED) threshold to declare the medium as IDLE.

The 802.11 specification defines the PD threshold as −82 dBm and ED threshold as −62 dBm for a 20 MHz channel, with a 3 dB increment for every doubling of channel bandwidth. BSS coloring allows the node to identify the current transmission, based on the BSS color in the PHY header of the incoming transmission, as an inter-BSS or intra-BSS transmission, and adjust the PD threshold for the inter-BSS transmission and transmit over the ongoing transmission. This mode of operation is called overlapping basic service set-packet detect (OBSS_PD) based SR. If the node ignores the inter-BSS transmission based on OBSS_PD based SR, the spec dictates that the node reduce the transmit power based on the OBSS_PD threshold chosen using the following equation:

TX_PWR=TX_PWR_{ref}−(OBSS_PDₗₑᵥₑₗ−OBSS_PDₘᵢₙ)+log₁₀(PPDU_BW/20 MHz), where OBSS_PDₘₐₓ≥OBSS_PDₗₑᵥₑₗ>OBSS_PDₘᵢₙ. OBSS_PDₘₐₓ=−62 dBm and OBSS_PDₘᵢₙ=−82 dBm for a PPDU_BW of 20 MHz.

The adjustment rule is illustrated in FIG. 3, which illustrates an example adjustment for TX_PWR in relation to OBSS_PD level according to embodiments of the present disclosure.

Various embodiments of the present disclosure recognize that the 802.11ax standard provides a new mechanism called OBSS-PD, which allows a station (STA) to transmit over inter-BSS physical layer protocol data units (PPDU's) by reducing its transmission power to avoid adding interference to the inter-BSS PPDU's. This is so that efficient re-utilization of spectrum is achieved while also limiting inter-BSS interference. However, the standard does not provide any guidelines on the length of the PPDU the STA is transmitting over the inter-BSS PPDU. In the case when the length of the PPDU is shorter or longer than the inter-BSS PPDU, the STA will miss the preamble of the current or next inter-BSS PPDU and access the channel using Energy Detection. This will allow the STA to sense the medium as idle and transmit using its full transmission power, instead of its reduced transmission power. This will increase the overall interference in the channel and reduce the overall channel capacity of the network.

Accordingly, various embodiments of the present disclosure provide mechanisms for a post OBSS_PD PPDU reduced ED threshold, where after the transmission of the PPDU using OBSS_PD, the STA can reduce the ED threshold to avoid mid packet wake up and interfering with another BSS's transmission. Further, various embodiments of the present disclosure provide mechanisms for delayed carrier sensing post OBSS_PD PPDU, where the STA can delay sensing the channel after transmission of the OBSS_PD PPDU to prevent mid packet wakeup and conserve energy. In addition, various embodiments of the present disclosure provide mechanisms for reducing transmission power to align with the OBSS_PD threshold. Further still, various embodiments of the present disclosure provide mechanisms for OBSS_PD PPDU duration alignment, where the STA can set the length of the OBSS_PD PPDU to match the length of the inter-BSS PPDU it is transmitting over.

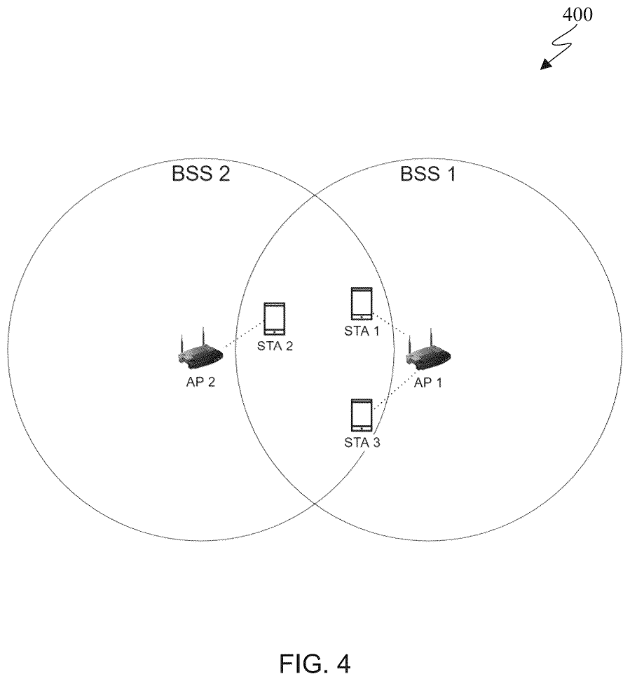

FIG. 4 illustrates an example topology 400 involving two overlapping BSSs according to embodiments of the present disclosure. The embodiment of the example topology 400 involving two overlapping BSSs shown in FIG. 4 is for illustration only. Other embodiments of the example topology 400 involving two overlapping BSSs could be used without departing from the scope of this disclosure.

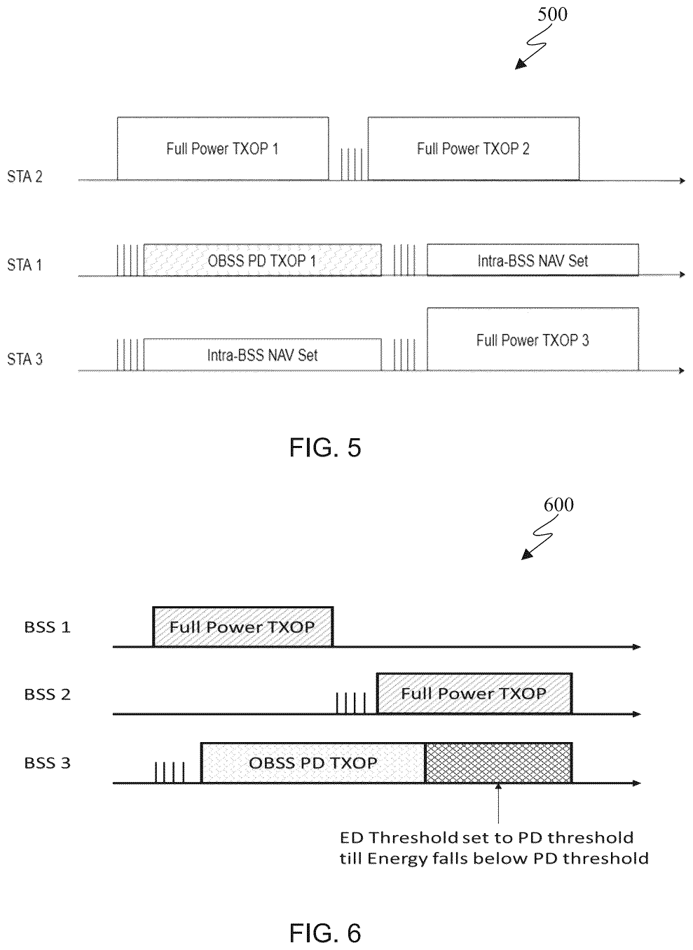

FIG. 5 illustrates an example packet transmission diagram 500 involving multiple STAs in overlapping BSSs according to embodiments of the present disclosure. The embodiment of the example packet transmission diagram 500 involving multiple STAs in overlapping BSSs shown in FIG. 5 is for illustration only. Other embodiments of the example packet transmission diagram 500 involving multiple STAs in overlapping BSSs could be used without departing from the scope of this disclosure.

As illustrated in FIG. 4, two overlapping BSSs (BSS 1 and BSS 2) that are operating on the same WiFi channel and are in close vicinity are shown. BSS 1 has one access point (AP1) and two associated non-AP stations (STA1, STA3), while BSS 2 has one access point (AP2) and one associated non-AP station (STA2). Let us further consider the scenario that STA2 has won a transmit opportunity (TXOP) and is sending one or more physical protocol data units (PPDUs) to AP2, and the devices in BSS 1 (AP1, STA1 and STA3) can observe the preambles of these PPDUs, as shown in FIG. 5. We shall refer to this TXOP as Full power TXOP 1. If the received power from the PPDUs in Full power TXOP1 are larger than −82 dBm, then under normal circumstances devices in BSS 1 sense the channel as busy and can't transmit packets. However, as described herein, OBSS_PD is a mechanism using which devices in BSS 1 can transmit PPDUs in parallel with the Full power TXOP 1, albeit with a lower transmit power to control the interference to BSS 2, as shown in FIG. 5. We shall refer to such a TXOP as OBSS_PD TXOP 1. Note that devices of BSS 1 can decode the duration of the Full power TXOP 1 by observing the PHY headers of the corresponding PPDUs. However, the transmission length or end time of the OBSS PD TXOP 1, initiated by any device in BSS 1, may not align with the duration or end time of Full power TXOP 1 for several reasons. For example, such reasons may include:
The access category of the OBSS_PD TXOP 1 may not allow it to use the full length of Full power TXOP 1 due to access category specific TXOP restrictions.
The amount of data in the buffer for the transmitter of the OBSS_PD TXOP 1 may be insufficient to generate a TXOP of the desired length.
The PPDU length of OBSS_PD TXOP 1 may be too short to accommodate the length of the data being transmitted using OBSS-PD.

This can lead to one of two cases:
1. OBSS_PD TXOP 1 ends before the Full power TXOP 1: In this case, after the end of the OBSS_PD TXOP 1, the devices in BSS1 may start sensing the channel midway through the Full power TXOP 1. Thus, if the received power from PPDUs in Full power TXOP 1 is between −62 dBm and −82 dBm, then the devices in BSS1 may sense the channel as idle by using energy detection method. Correspondingly, upon winning channel access, a device in BSS 1 may start transmitting PPDUs at full power harming the reception of Full power TXOP 1.
2. OBSS_PD TXOP 1 ends after the Full power TXOP 1: In this case, after the end of the Full power TXOP 1, the devices in BSS2 may sense the channel as idle, since the OBSS_PD TXOP power is low, and thus initiate a new Full power TXOP 2. The OBSS_PD TXOP 1 may end halfway through this new Full power TXOP 2 in BSS 2. Correspondingly the same situation as condition 1 may apply again, this time harming the reception of Full power TXOP 2.

This can degrade the overall network performance since by using OBSS_PD, devices in BSS may be more likely to miss the preambles of the Full power TXOPs transmitted in another overlapping BSS and cause harmful interference. In this disclosure, we propose several embodiments to prevent such harmful transmissions.

In one embodiment, the STA initiating an OBSS_PD TXOP by practicing OBSS-PD, may follow a conservative channel access procedure for some duration after the end of the OBSS_PD TXOP. In one variant of this embodiment, this conservative channel access procedure may be followed by both the transmitting and receiving devices of the PPDUs in the OBSS_PD TXOP. In yet another variant, all devices in the BSS corresponding to the STA shall follow the conservative channel access procedure.

The conservative channel access procedure may involve, for example, lowering the energy detection (ED) threshold or preventing ED based sensing of channel as idle. In one example, this lower ED threshold can be the same as the preamble detection (PD) threshold, and in another case, the lower ED threshold can be equal to the OBSS-PD threshold. In another variant, the lower ED threshold can be set to the OBSS-PD threshold if the STA has not sensed any packet from another BSS with the PSR_AND_NON_SRG_OBSS_PD_PROHIBITED bit or SR_RESTRICTED bit set to true previously in the medium, and otherwise, it can set the ED threshold equal to the PD threshold.

The duration of the conservative procedure can be either a fixed time duration, or until the reception of a preamble of a packet to set the NAV timer, or until sensing the channel as busy due to another transmission or, in one variant, it can be the minimum of one or more of these conditions.

For example, in one implementation of this embodiment, the process may involve reducing the energy detection (ED) threshold and setting it to the PD threshold until the energy in the channel falls below the PD threshold as shown in FIG. 6, which illustrates an example channel access procedure 600 involving reducing the energy detection (ED) threshold until the energy in the channel falls below the preamble detection threshold according to embodiments of the present disclosure. The embodiment of the example channel access procedure 600 involving reducing the energy detection (ED) threshold until the energy in the channel falls below the preamble detection threshold shown in FIG. 6 is for illustration only. Other embodiments of the example channel access procedure 600 involving reducing the energy detection (ED) threshold until the energy in the channel falls below the preamble detection threshold could be used without departing from the scope of this disclosure.

In one embodiment, the STA that initiates a parallel TXOP by practicing OBSS-PD can delay carrier sensing for some duration to prevent mid packet wake up. However, different from the embodiment described above, the conservative channel access duration can be different based on the circumstances. For example, the procedure can be different based on if the OBSS_PD TXOP is shorter or longer than the inter-BSS TXOP that it transmits over.

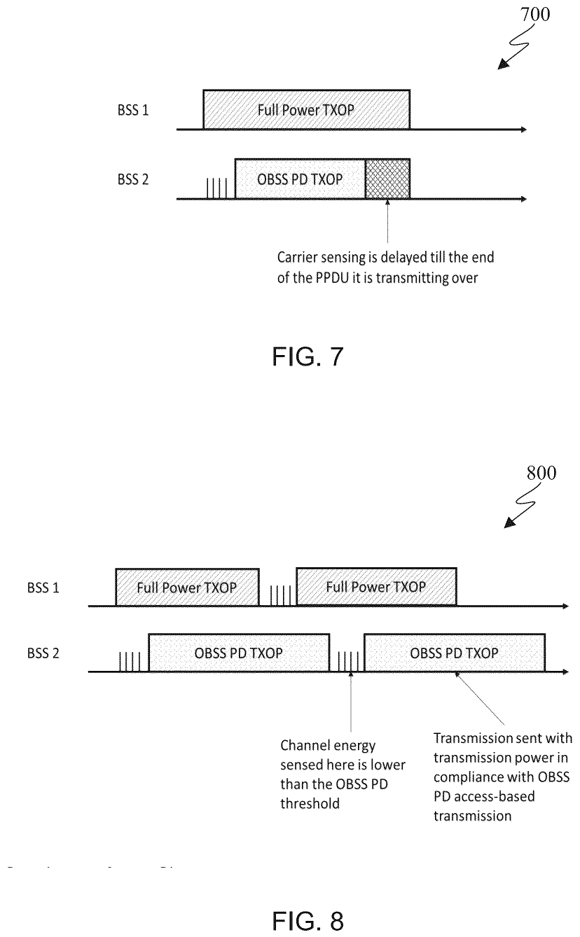

FIG. 7 illustrates an example involving delaying carrier sensing for a duration of time 700 according to embodiments of the present disclosure. The embodiment of the example involving delaying carrier sensing for a duration of time 700 shown in FIG. 7 is for illustration only. Other embodiments of the example involving delaying carrier sensing for a duration of time 700 could be used without departing from the scope of this disclosure.

For example, in one variant, if the OBSS_PD PPDU is shorter than the inter-BSS PPDU, the STA can delay either the ED-based carrier sensing or both ED-based and PD-based channel sensing until the end of the inter-BSS PPDU as shown in FIG. 7. If the OBSS_PD PPDU is longer than the inter-BSS PPDU, the STA can delay the carrier sensing for a fixed amount depending on certain conditions:
The first sensing can be scheduled to (Beacon Length−(OBSS_PD PPDU end time−inter-BSS PPDU end time))
The next sensing can be schedule to (AC_VO TXOP length−(OBSS_PD PPDU end time−inter-BSS PPDU end time))
The next sensing can be schedule to (AC_VI TXOP length−(OBSS_PD PPDU end time−inter-BSS PPDU end time))
The last sensing can be schedule to (Maximum A-MPDU length−(OBSS_PD PPDU end time−inter-BSS PPDU end time)).

If the STA cannot sense the channel idle during the last sensing, then it can revert to other embodiments described herein. In some variants of this embodiment, the aforementioned channel access procedure can also be followed by the recipient of PPDUs in the OBSS_PD TXOP or can be followed by all devices in the BSS of the STA.

In one embodiment, instead of following a conservative channel access procedure, the transmit power for the next TXOP initiated by the STA that transmitted the OBSS_PD TXOP is determined conservatively. For example, in one variant, the STA that initiates the parallel TXOP by practicing OBSS-PD, upon sensing the medium as Idle using the ED threshold after end of the OBSS_PD TXOP, shall transmit the PPDUs of the next TXOP with a fixed reduction of transmit power. In another variant, the STA that initiates the parallel TXOP by practicing OBSS-PD, upon sensing the medium as Idle using the ED threshold after end of the OBSS_PD TXOP, adjusts the transmission power in accordance similar to how adjustment is done for operating in OBSS-PD operating under the assumption that the signal is a Wi-Fi signal.

FIG. 8 illustrates an example involving reducing transmit power if energy sensed on the channel is less than the OBSS PD threshold 800 according to embodiments of the present disclosure. The embodiment of the example involving reducing transmit power if energy sensed on the channel is less than the OBSS PD threshold 800 shown in FIG. 8 is for illustration only. Other embodiments of the example involving reducing transmit power if energy sensed on the channel is less than the OBSS PD threshold 800 could be used without departing from the scope of this disclosure.

As an illustration, if the node senses the channel power as −70 dBm via energy detection and its OBSS_PD threshold is −69 dBm then it can use a transmission power of 8 dB for the PPDU(s) of the next TXOP as shown in FIG. 8. In yet another variant, this embodiment can only be used if the STA has not sensed any packet with the PSR_AND_NON_SRG_OBSS_PD_PROHIBITED bit or SR_RESTRICTED bit set to true or, with the BSS color set to 0 previously in the medium. An exemplary condition for this can be if even 1 PPDU is experienced by the node in the last 5 seconds with the PSR_AND_NON_SRG_OBSS_PD_PROHIBITED bit or SR_RESTRICTED bit set to true, or BSS Color set to 0.

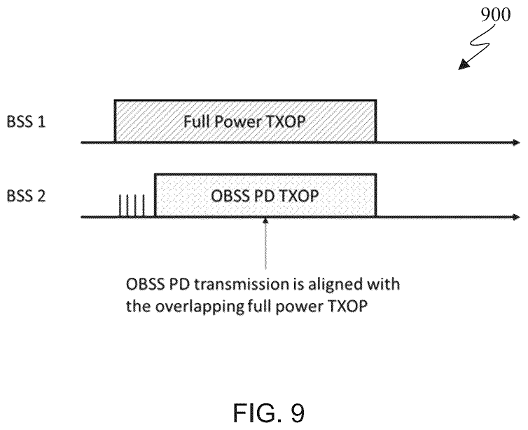

FIG. 9 illustrates an example involving duration alignment between the OBSS PD transmission and the overlapping inter-BSS physical layer protocol data unit (PPDU) 900 according to embodiments of the present disclosure. The embodiment of the example involving duration alignment between the OBSS PD transmission and the overlapping inter-BSS physical layer protocol data unit (PPDU) 900 shown in FIG. 9 is for illustration only. Other embodiments of the example involving duration alignment between the OBSS PD transmission and the overlapping inter-BSS physical layer protocol data unit (PPDU) 900 could be used without departing from the scope of this disclosure.

In one embodiment, the devices involved in the transmission or reception of the PPDUs in the OBSS_PD TXOP (i.e., OBSS_PD TXOP 1 in FIG. 5) by practicing OBSS-PD may ensure that the duration of the OBSS_PD TXOP matches that of the inter-BSS TXOP they overlap with (i.e., Full power TXOP 1 in FIG. 5). In one case, the STA initiating the OBSS_PD TXOP can set the duration of its TXOP to match the end time of the inter-BSS PPDU as shown in FIG. 9. If the PPDU cannot be generated with the current data on the buffer, then the data can be padded to make the TXOP to end with the inter-BSS PPDU. In another variant, the receiver of the OBSS_PD PPDU can also act to early terminate the OBSS_PD TXOP to align with the inter-BSS PPDU. For example, in one case the AP of the BSS may be responsible for ensuring that the OBSS_PD TXOP end time aligns with the inter-BSS PPDU, independent of whether it is the transmitter or the receiver of the OBSS_PD TXOP.

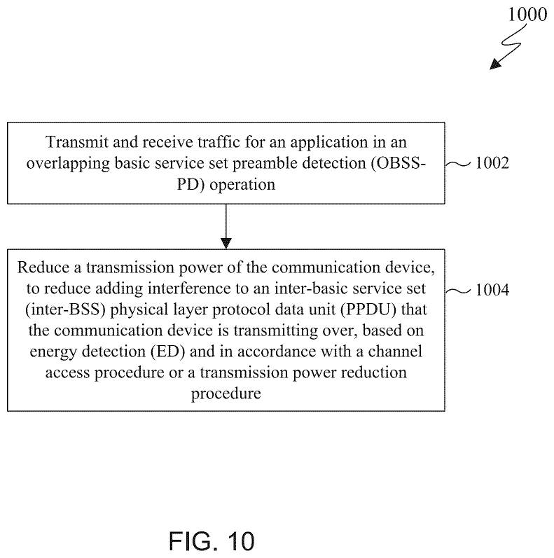

FIG. 10 illustrates a flowchart of a method 1000 for wireless communication performed by a communication device such as a STA according to embodiments of the present disclosure. The embodiment of the method 1000 for wireless communication performed by a communication device shown in FIG. 10 is for illustration only. Other embodiments of the method 1000 for wireless communication performed by a communication device could be used without departing from the scope of this disclosure.

As illustrated in FIG. 10, the method 1000 begins at step 1002, where the communication device transmits and receives traffic for an application in an overlapping basic service set preamble detection (OBSS-PD) operation. At step 1004, the communication device reduces a transmission power of the communication device, to reduce adding interference to an inter-basic service set (inter-BSS) physical layer protocol data unit (PPDU) that the communication device is transmitting over, based on energy detection (ED) and in accordance with a channel access procedure or a transmission power reduction procedure.

In one embodiment, the communication device follows the channel access procedure for a duration of time after an end of the inter-BSS PPDU that the communication device is transmitting over; and reduces an ED threshold as a function of a preamble threshold; or reduces the ED threshold as a function of an OBSS-PD threshold.

In one embodiment, the communication device prevents ED-based sensing of a channel as idle.

In one embodiment, the communication device delays carrier sensing for a duration of time.

In one embodiment, the communication device determines a duration of a physical layer protocol data unit (PPDU) that the communication device is transmitting over; compares the duration of the PPDU that the communication device is transmitting over to a duration of inter-basic service set (inter-BSS) PPDUs that the communication device is transmitting over; when the duration of the PPDU that the communication device is transmitting over is shorter than the duration of the inter-BSS PPDU that the communication device is transmitting over, delays either an ED-based carrier sensing or both an ED-based and preamble detection (PD) based channel sensing until an end of the inter-BSS PPDU; and when the duration of the PPDU that the communication device is transmitting over is longer than the duration of the inter-BSS PPDU that the communication device is transmitting over, delays the carrier sensing for a fixed amount of time.

In one embodiment, the communication device senses a medium as idle based on an ED threshold; and transmits a next inter-BSS PPDU with a fixed reduction of transmit power.

In one embodiment, the communication device matches a duration of time of the PPDU that the communication device is transmitting over to a duration of time of an overlapping inter-BSS PPDU that the communication device is transmitting over.

In one embodiment, the communication device sets a duration of time the PPDU that the communication device is transmitting over to correspond to an end time of the overlapping inter-BSS PPDU that the communication device is transmitting over.

The above flowcharts illustrate example methods that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A communication device comprising:
a transceiver configured to transmit and receive traffic for an application in an overlapping basic service set preamble detection (OBSS-PD) operation; and
a processor operably coupled to the transceiver, the processor configured to reduce a transmission power of the communication device, to reduce adding interference to an inter-basic service set (inter-BSS) physical layer protocol data unit (PPDU) that the communication device is transmitting over, based on energy detection (ED) and in accordance with a channel access procedure or a transmission power reduction procedure.

2. The communication device of claim 1, wherein:
the channel access procedure is followed for a duration of time after an end of the inter-BSS PPDU that the communication device is transmitting over, and
to perform the channel access procedure, the processor is configured to:
reduce an ED threshold as a function of a preamble threshold; or
reduce the ED threshold as a function of an OBSS-PD threshold.

3. The communication device of claim 1, wherein to perform the channel access procedure, the processor is configured to prevent ED-based sensing of a channel as idle.

4. The communication device of claim 1, wherein to perform the channel access procedure, the processor is configured to delay carrier sensing for a duration of time.

5. The communication device of claim 4, wherein to delay carrier sensing, the processor is further configured to:
determine a duration of a physical layer protocol data unit (PPDU) that the communication device is transmitting over;
compare the duration of the PPDU that the communication device is transmitting over to a duration of inter-basic service set (inter-BSS) PPDUs that the communication device is transmitting over;
when the duration of the PPDU that the communication device is transmitting over is shorter than the duration of the inter-BSS PPDU that the communication device is transmitting over, delay either an ED-based carrier sensing or both an ED-based and preamble detection (PD) based channel sensing until an end of the inter-BSS PPDU; and
when the duration of the PPDU that the communication device is transmitting over is longer than the duration of the inter-BSS PPDU that the communication device is transmitting over, delay the carrier sensing for a fixed amount of time.

6. The communication device of claim 1, wherein to perform the transmission power reduction procedure, the processor is configured to:
sense a medium as idle based on an ED threshold; and
transmit a next inter-BSS PPDU with a fixed reduction of transmit power.

7. The communication device of claim 1, wherein to perform the transmission power reduction procedure, the processor is configured to match a duration of time of the PPDU that the communication device is transmitting over to a duration of time of an overlapping inter-BSS PPDU that the communication device is transmitting over.

8. The communication device of claim 7, wherein to perform the transmission power reduction procedure, the processor is further configured to set a duration of time the PPDU that the communication device is transmitting over to correspond to an end time of the overlapping inter-BSS PPDU that the communication device is transmitting over.

9. A method for wireless communication performed by a communication device communication device, the method comprising:
transmitting and receiving traffic for an application in an overlapping basic service set preamble detection (OBSS-PD) operation; and
reducing a transmission power of the communication device, to reduce adding interference to an inter-basic service set (inter-BSS) physical layer protocol data unit (PPDU) that the communication device is transmitting over, based on energy detection (ED) and in accordance with a channel access procedure or a transmission power reduction procedure.

10. The method of claim 9, further comprising:
following the channel access procedure for a duration of time after an end of the inter-BSS PPDU that the communication device is transmitting over; and
reducing an ED threshold as a function of a preamble threshold; or
reducing the ED threshold as a function of an OBSS-PD threshold.

11. The method of claim 9, further comprising preventing ED-based sensing of a channel as idle.

12. The method of claim 9, further comprising delaying carrier sensing for a duration of time.

13. The method of claim 12, further comprising:
determining a duration of a physical layer protocol data unit (PPDU) that the communication device is transmitting over;
comparing the duration of the PPDU that the communication device is transmitting over to a duration of inter-basic service set (inter-BSS) PPDUs that the communication device is transmitting over;
when the duration of the PPDU that the communication device is transmitting over is shorter than the duration of the inter-BSS PPDU that the communication device is transmitting over, delaying either an ED-based carrier sensing or both an ED-based and preamble detection (PD) based channel sensing until an end of the inter-BSS PPDU; and
when the duration of the PPDU that the communication device is transmitting over is longer than the duration of the inter-BSS PPDU that the communication device is transmitting over, delaying the carrier sensing for a fixed amount of time.

14. The method of claim 9, further comprising:
sensing a medium as idle based on an ED threshold; and
transmitting a next inter-BSS PPDU with a fixed reduction of transmit power.

15. The method of claim 9, further comprising matching a duration of time of the PPDU that the communication device is transmitting over to a duration of time of an overlapping inter-BSS PPDU that the communication device is transmitting over.

16. The method of claim 15, further comprising setting a duration of time the PPDU that the communication device is transmitting over to correspond to an end time of the overlapping inter-BSS PPDU that the communication device is transmitting over.

17. An access point (AP) comprising:
a processor configured to generate traffic for an application in an overlapping basic service set preamble detection (OBSS-PD) operation; and
a transceiver configured to:
transmit the traffic for the application in the OBSS-PD operation; and
receive an inter-basic service set (inter-BSS) physical layer protocol data unit (PPDU) from a communication device, the inter-BSS PPDU having a reduced transmission power to reduce interference to the inter-BSS PPDU that the communication device is transmitting over, based on energy detection (ED) and in accordance with a channel access procedure or a transmission power reduction procedure.

18. The AP of claim 17, wherein:
the channel access procedure is followed for a duration of time after an end of the inter-BSS PPDU that the communication device is transmitting over, and
to perform the channel access procedure, the processor is configured to:
reduce an ED threshold as a function of a preamble threshold; or
reduce the ED threshold as a function of an OBSS-PD threshold.

19. The AP of claim 17, wherein to perform the transmission power reduction procedure, the processor is configured to match a duration of time of the PPDU that the communication device is transmitting over to a duration of time of an overlapping inter-BSS PPDU that the communication device is transmitting over.

20. The AP of claim 19, wherein to perform the transmission power reduction procedure, the processor is further configured to set a duration of time the PPDU that the communication device is transmitting over to correspond to an end time of the overlapping inter-BSS PPDU that the communication device is transmitting over.
